(19) United States
(12) Patent Application Publication
(10) Pub. No.: US 2007/0148399 A1
(43) Pub. Date: Jun. 28, 2007

(54) Method of fabricating a conductive textile

(76) Inventor: Shin-Chieh Chen, Taoyuan City (TW)

Correspondence Address: KNOBBE MARTENS OLSON & BEAR LLP, 2040 MAIN STREET, FOURTEENTH FLOOR, IRVINE, CA, 92614, US

(21) Appl. No.: 11/317,440

(22) Filed: Dec. 22, 2005

(51) Int. Cl. B32B 33/00; B32B 3/02

(52) U.S. Cl. 428/96; 428/90; 428/91

(57) ABSTRACT

A method of fabricating a conductive textile is provided. First, erect-interlaced fibers are formed on a textile. Then, a conductive layer is formed on the erect-interlaced fibers and the surface of the textile to form a conductive textile.

### FIELD OF INVENTION

The present invention relates to a method of fabricating a functional textile. More particularly, the present invention relates to a method of fabricating a conductive textile.

### DESCRIPTION OF RELATED ART

With increases in living quality, the demand for functional textile, such as a conductive textile, fire-retardant textile, and antibacterial textile, has been raised. Conductive textile can be made into antistatic clothing, which is applied to industries requiring static protection, such as the petroleum industry, chemical industry, machinery industry, food products, and medicine. Furthermore, conductive textile can be applied in physical therapy, for example, in impulse electrotherapy used for stimulating reflex points of the palm and foot to reduce pain.

There are two conventional methods of producing a conductive textile. One method is illustrated in FIG. 1, which is a schematic diagram showing a long metal fiber intertwined with a long non-metal fiber. Conductive yarn 100 is formed by spinning long metal fibers 102 with long fibers 104, which is then woven into a conductive textile. However, since the conductive textile is only conductive through the metal fibers, it is conductive in only one dimension, not in a uniformly conductive plane.

Another method is to deposit a conductive layer consisting of resin and conductive materials to form a conductive textile that is conductive in a uniformly conductive plane. However, unless the thickness of the conductive layer is increased, electrical conductivity is reduced because of bad step coverage of the conductive layer formed on the rough surface of the textile. A thicker conductive layer formed on the textile, though, reduces the softness of the textile. Thus, a method of fabricating a conductive textile is required to solve these problems.

### SUMMARY

In one aspect, this present invention provides a method of fabricating a conductive textile offering increased conductivity over the prior art.

In another aspect, this present invention provides a method of fabricating a conductive textile that provides a uniform and overall conductive film on the textile.

In accordance with the foregoing and other aspects of the present invention, the present invention provides a method of fabricating a conductive textile. First, a textile is provided. Then, a surface of the textile is roughened to form erect-interlaced fibers on the surface of the textile. A conductive layer is formed on the surface of the erect-interlaced fibers and the textile to form a conductive textile. The erect-interlaced fibers are entwined and protruding on the surface of the textile, so that the conductive layer can be formed on the surface of the textile and the erect-interlaced fibers to form an effective conductive path on the surface of the textile. Thus, surface area of the conductive layer on the erect-interlaced fibers and the textile for conducting electric current is increased so that more electric current can be passed through the conductive layer. Moreover, resistance of the conductive textile is reduced and thus conductivity of the conductive textile is increased.

According to one embodiment of the present invention, the step of forming the erect-interlaced fibers is preferably by scraping the surface of the textile or flocking short fibers on the surface of the textile.

According to one embodiment of the present invention, the short fibers are less than 3 mm long.

According to one embodiment of the present invention, the step of forming the conductive layer is by performing a vacuum coating process or a non-vacuum coating process.

In the foregoing, the conductive textile produced according to one embodiment of the present invention has better conductivity than that of the prior art. A surface of the textile is roughened to form erect-interlaced fibers on the surface of the textile according to one embodiment of the present invention. The erect-interlaced fibers are entwined and protruding on the surface of the textile, so that the conductive layer can be formed on the surface of the textile and the erect-interlaced to form an effective conductive path on the surface of the textile. Thus, the surface area of the erect-interlaced fibers and the surface of the textile in which electric current is passed through are increased. Moreover, the conductivity of the conductive textile is increased, and the conductive textile produced according to one embodiment of the present invention has a uniform and overall conductive film to enhance the conductivity of the conductive textile.

It is to be understood that both the foregoing general description and the following detailed description are by examples and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 is a schematic diagram showing a long metal fiber intertwined with a long fiber.

FIG. 2 is an electron microscope image showing a woven fabric according to one embodiment of the present invention.

FIG. 3 is an electron microscope image showing bristled fibers formed on the woven fabric according to one embodiment of the present invention.

FIG. 4 is an electron microscope image showing flocking fibers formed on the textile according to another embodiment of the present invention.

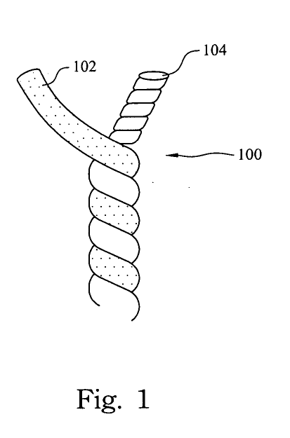

### DESCRIPTION OF THE PREFERRED EMBODIMENTS

First, a textile is provided. Then, a surface of the textile is roughened to form erect-interlaced fibers on the surface of the textile. The erect-interlaced fibers are entwined and protruding on the surface of the textile so that the surface area of the textile is increased. The step of forming the erect-interlaced fibers is preferably by scraping the surface of the textile or flocking short fibers on the surface of the textile.

Then, a vacuum coating process or a non-vacuum coating process is performed to form a conductive layer on the surface of the erect-interlaced fibers and of the textile to form a conductive textile. The erect-interlaced fibers are entwined and protruding on the surface of the textile so that an effective conductive path is formed and so that the surface area of the conductive layer on the erect-interlaced fibers and the textile for conducting electric current is increased to reduce resistivity of the conductive textile. Thus, the conductivity of the textile is improved. The thickness of the conductive layer is preferably between 0.2 μm and 0.55 μm.

The material of the conductive layer are preferably elemental metal, metallic alloy, metal oxide, metal carbide, or metal nitride, more preferably Ti, V, Cr, W, Mn, Fe, Co, Ni, Pd, Pt, Cu, Ag, Au, Zn, Al, In, or Sn. However, the present invention can also use other conductive materials to form the conductive layer.

According to one embedment of the present invention, the vacuum coating process, such as a sputtering method or an evaporation method, is performed at a preferred pressure between 10⁻¹ torr and 10⁻⁴ torr, more preferably, between 10⁻² torr and 10⁻³ torr to form a conductive layer on the surface of the textile. Alternatively, a non-vacuum coating process, such as a spraying method, can be used to spray a solution of the conductive materials on the surface of the textile. The spray method is apparent to those skilled in the art so the description relating to those steps is not repeated here.

The following description describes two methods to form erect-interlaced fibers according to two embodiments of the present invention. However, the present invention can also use other methods to form the erect-interlaced fibers.

### Embodiment 1

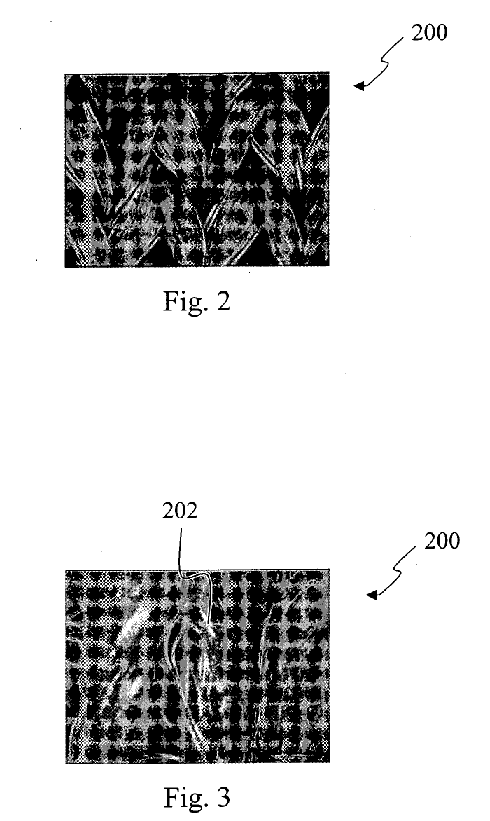

According to a preferred embodiment of the present invention, a scraping method is performed on the surface of the textile to form the erect-interlaced fibers. FIG. 2 is an electron microscope image showing a knitting fabric according to one embodiment of the present invention. First, according to a preferred embodiment of the present invention, a knitting fabric 200 is used as a textile. The surface of the knitting fabric 200 is scraped back and forth to form nap 202 (erect-interlaced fibers) on the surface of the knitting fabric 200, as shown in FIG. 3. The roughness degree of the surface of the knitting fabric 200 is according to demands. Alternatively, a fleece process can be performed after forming the nap 202 on the surface of the knitting fabric 200 according to demands to entwine the nap 202 on the surface of the knitting fabric 200 and increase the structural stability of the nap 202.

Then, a vacuum coating process is performed at a preferred pressure between 10⁻² torr and 10⁻³ torr for about 20 minutes to sputter silver to form a silver layer on the surface of the erect-interlaced fibers and the nap 202. Consequently, a conductive textile is formed. The thickness of the silver layer is preferably between about 0.2 μm and about 0.55 μm.

After a conductive textile was produced according to this embodiment of the present invention, it and a traditional conductive textile were subjected to an electric resistance test. The results are listed in the following Table 1.

TABLE 1
Electric resistance test of conductive textile

| | Traditional conductive textile | Conductive textile |
|---|---|---|
| Resistivity (Ω/cm) | >1,000,000 | 23 |
| | (too high to measure) | |

From the results above, the conductive textile produced according to this embodiment of the present invention has much lower resistivity. In other words, the conductive textile produced according to this embodiment of the present invention has better conductivity.

### Embodiment 2

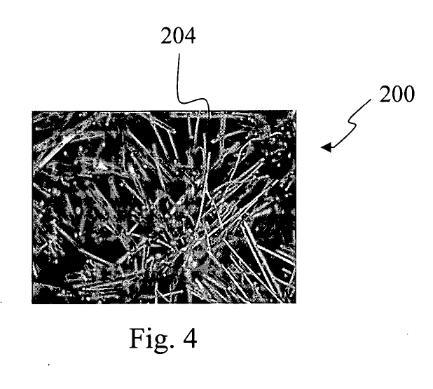

According to another preferred embodiment of the present invention, a flocking method is performed on the surface of the textile to form the erect-interlaced fibers. FIG. 4 is an electron microscope image showing flocking fibers formed on the textile according to another embodiment of the present invention. First, adhesive is coated on a textile 200 to form an adhesive layer. Short fibers 204 are flocked on the adhesive layer of the surface of the textile 200 to form erect-interlaced fibers. The short fibers 204 are preferably less than 3 mm long and the diameter of the short fibers 204 is preferably less than 0.01 mm. The short fibers 204 are 1 mm long according to the embodiment of the present invention.

Next, a vacuum coating process is performed at a preferred pressure between 10⁻² torr and 10⁻³ torr for about 20 minutes to sputter silver to form a silver layer on the surface of the erect-interlaced fibers and the textile. Consequently, a conductive textile is formed. The thickness of the silver layer is preferably between about 0.2 μm and 0.55 μm.

After the conductive textile was produced according to the embodiment of the present invention, it and a traditional conductive textile were subjected to an electric resistance test. The results are listed in the following Table 2.

TABLE 2
Electric resistance test of conductive textile

| | Traditional conductive textile | Conductive textile |
|---|---|---|
| Resistivity (Ω/cm) | >1,000,000 | 100 |
| | (too high to measure) | |

From the results above, the conductive textile produced according to this embodiment of the present invention has lower resistivity. In other words, the conductive textile produced according to this embodiment of the present invention has better conductivity.

In the foregoing, the conductive textile produced according to one embodiment of the present invention has better conductivity. A surface of the textile is roughened to form erect-interlaced fibers on the surface of the textile according to one embodiment of the present invention. The erect-interlaced fibers are entwined and protruding on the surface of the textile, so that the conductive layer can be formed thereon to form an effective conductive path on the surface of the textile. Thus, the surface area of the conductive layer on the erect-interlaced fibers and the textile for conducting electric current is increased and more electric current can be passed through the conductive layer. Moreover, the conductive textile produced according to the embodiments of the present invention has a uniform and overall conductive film to enhance the conductivity of the conductive textile.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of fabricating a conductive textile, the method comprising:
forming erect-interlaced fibers on a surface of a textile;
forming a conductive layer on the erect-interlaced fibers and the surface of the textile to form a conductive textile.

2. The method of fabricating a conductive textile of claim 1, wherein the step of forming the erect-interlaced fibers comprises scraping the surface of the textile.

3. The method of fabricating a conductive textile of claim 1, wherein the step of forming the erect-interlaced fibers comprises flocking short fibers on the surface of the textile.

4. The method of fabricating a conductive textile of claim 3, wherein the short fibers are less than 3 mm long.

5. The method of fabricating a conductive textile of claim 1, wherein a step of forming the conductive layer comprises performing a vacuum coating process or a non-vacuum coating process.

6. The method of fabricating a conductive textile of claim 5, wherein the vacuum coating process is selected from a group consisting of sputtering and evaporation.

7. The method of fabricating a conductive textile of claim 6, wherein the vacuum coating process is performed at a pressure between 10⁻¹ torr and 10⁻⁴ torr.

8. The method of fabricating a conductive textile of claim 5, wherein the non-vacuum coating process is a spraying method.

9. The method of fabricating a conductive textile of claim 1, wherein materials of the conductive layer are selected from a group consisting of elemental metal, metallic alloy, metal oxide, metal carbide, and metal nitride.

10. The method of fabricating a conductive textile of claim 1, wherein materials of the conductive layer are selected from Ti, V, Cr, W, Mn, Fe, Co, Ni, Pd, Pt, Cu, Ag, Au, Zn, Al, In, and Sn.

11. A method of fabricating a conductive textile, the method comprising:
roughening a surface of a textile to form a erect-interlaced fibers on the surface of the textile;
performing a metallization process to form a conductive layer on the erect-interlaced fibers and the surface of the textile.

12. The method of fabricating a conductive textile of claim 11, wherein the step of roughening the surface of a textile comprises scraping the surface of the textile.

13. The method of fabricating a conductive textile of claim 11, wherein the step of roughening the surface of a textile comprises flocking short fibers on the surface of the textile.

14. The method of fabricating a conductive textile of claim 13, wherein the short fibers are less than 3 mm long.

15. The method of fabricating a conductive textile of claim 11, wherein the step of performing the metallization process comprises performing a vacuum coating process or a non-vacuum coating process.

16. The method of fabricating a conductive textile of claim 15, wherein the vacuum coating process is selected from a group consisting of sputtering and evaporation.

17. The method of fabricating a conductive textile of claim 16, wherein the vacuum coating process is performed at a pressure between 10⁻¹ torr and 10⁻⁴ torr.

18. The method of fabricating a conductive textile of claim 11, wherein materials of the conductive layer are selected from a group consisting of elemental metal, metallic alloy, metal oxide, metal carbide, and metal nitride.

19. The method of fabricating a conductive textile of claim 11, wherein materials of the conductive layer are selected from Ti, V, Cr, W, Mn, Fe, Co, Ni, Pd, Pt, Cu, Ag, Au, Zn, Al, In, and Sn.

20. A conductive textile, wherein improvement comprises:
a surface of the conductive textile having erect-interlaced fibers and a surface of the erect-interlaced fibers having a conductive layer.

21. The conductive textile of claim 20, wherein materials of the conductive layer are selected from a group consisting of elemental metal, metallic alloy, metal oxide, metal carbide, and metal nitride.

22. The conductive textile of claim 20, wherein materials of the conductive layer are selected from Ti, V, Cr, W, Mn, Fe, Co, Ni, Pd, Pt, Cu, Ag, Au, Zn, Al, In, and Sn.
